(19) United States
(12) Patent Application Publication
(10) Pub. No.: US 2016/0210619 A1
(43) Pub. Date: Jul. 21, 2016

(54) BLACKLIST UPDATING SYSTEM, TERMINAL DEVICE, METHOD, AND PROGRAM RECORDING MEDIUM

(71) Applicant: NEC Corporation, Minato-ku, Tokyo (JP)

(72) Inventors: SABURO SHIOTA, Tokyo (JP); YUICHI KOIKE, Tokyo (JP)

(73) Assignee: NEC Corporation, Minato-ku, Tokyo (JP)

(21) Appl. No.: 14/914,901

(22) PCT Filed: Aug. 21, 2014
(86) PCT No.: PCT/JP2014/004283

§ 371 Date: Feb. 26, 2016

(30) Foreign Application Priority Data
Sep. 19, 2013 (JP) 2013-193674

(51) Int. Cl. G06Q 20/38

(52) U.S. Cl. CPC G06Q 20/382

(57) ABSTRACT

A blacklist updating technique capable of efficiently preventing illegal use is provided. A terminal device includes a list storage means for storing a blacklist including invalidated identifiers, a processing means for checking, when an amount of money and the identifier are inputted, whether the input identifier is included in the blacklist in the list storage means and, when not included, executing a predetermined process using the amount of money and accumulating a predetermined value to obtain a cumulative value, and a list updating means for receiving update data from a server device to update the blacklist in the list storage means when the cumulative value is larger than a predetermined threshold.

### TECHNICAL FIELD

The present invention relates to a blacklist updating system, a terminal device, a method, and a program recording medium, and in particular, to a system, a terminal device, a method, and a program recording medium for controlling, for example, valid/invalid of a credit card using a blacklist.

### BACKGROUND ART

PTL 1 discloses a system that executes processing of a use stop for a credit card illegally used to buy a product or a service. Herein, the processing of a use stop refers to processing for destroying a part of information written on a card, processing for writing wrong information on a card, or processing for setting a flag indicating unusable (invalid) for a card.

In the system, invalid information of credit cards of credit company members is collected in a card management center. A host computer of the card management center outputs information including a blacklist of credit cards as card information. The blacklist is a list of invalid cards. A terminal computer of a member store receives and stores the information, and executes processing of a card use stop when a credit card input to a card reader is listed on the blacklist.

In the system, the host computer transmits information of all the card members regularly or irregularly to a terminal computer. When the terminal computer holds basic card information, the host computer transmits only information at the time when a credit card changes from valid to invalid or from invalid to valid, and the member store updates the basic information.

### CITATION LIST

### Patent Literature

[PTL 1] Japanese Laid-open Patent Publication No. 11-143949

### SUMMARY OF INVENTION

### Technical Problem

In the system of PTL 1, a card management center uniformly transmits card information including a blacklist to all member stores. However, all the member stores need not update data of the blacklist at the same frequency. When an update frequency of the blacklist is controlled in accordance with a height of a risk of illegal use of a card, the illegal use can be efficiently prevented.

An object of the present invention is to provide a blacklist updating system and the like capable of solving the problem and efficiently preventing illegal use of a credit card or the like.

### Solution to Problem

A terminal device according to an exemplary aspect of the invention includes: a list storage means for storing a blacklist including invalidated identifiers; a processing means for checking, when an amount of money and the identifier are inputted, whether the input identifier is included in the blacklist in the list storage means and, when not included, executing a predetermined process using the amount of money and accumulating a predetermined value to obtain a cumulative value; and a list updating means for receiving update data from a server device to update the blacklist in the list storage means when the cumulative value is larger than a predetermined threshold.

A method according to an exemplary aspect of the invention includes: storing a blacklist including invalidated identifiers; checking, when an amount of money and the identifier are inputted, whether the input identifier is included in the stored blacklist and, when not included, executing a predetermined process using the amount of money and accumulating a predetermined value to obtain a cumulative value; and receiving update data from a server device to update the stored blacklist when the cumulative value is larger than a predetermined threshold.

### Advantageous Effects of Invention

A blacklist updating system according to the present invention efficiently prevents illegal use of a credit card or the like.

### BRIEF DESCRIPTION OF DRAWINGS

FIG. 1 is a configuration diagram of a blacklist updating system 4 according to a first exemplary embodiment.

FIG. 2 illustrates a configuration of a blacklist 61 stored on a list storage 12 of a terminal device 1 and a list master storage 22 of a server device 2.

FIG. 3 is an operation flowchart of a processor 13 of the terminal device 1.

FIG. 4 is an operation flowchart of a list updating module 14 of the terminal device 1.

FIG. 5 is an operation flowchart of a master managing module 24 of a server device 2.

FIG. 6 is a configuration diagram of a terminal device 1 according to a second exemplary embodiment.

### DESCRIPTION OF EMBODIMENTS

### First Exemplary Embodiment

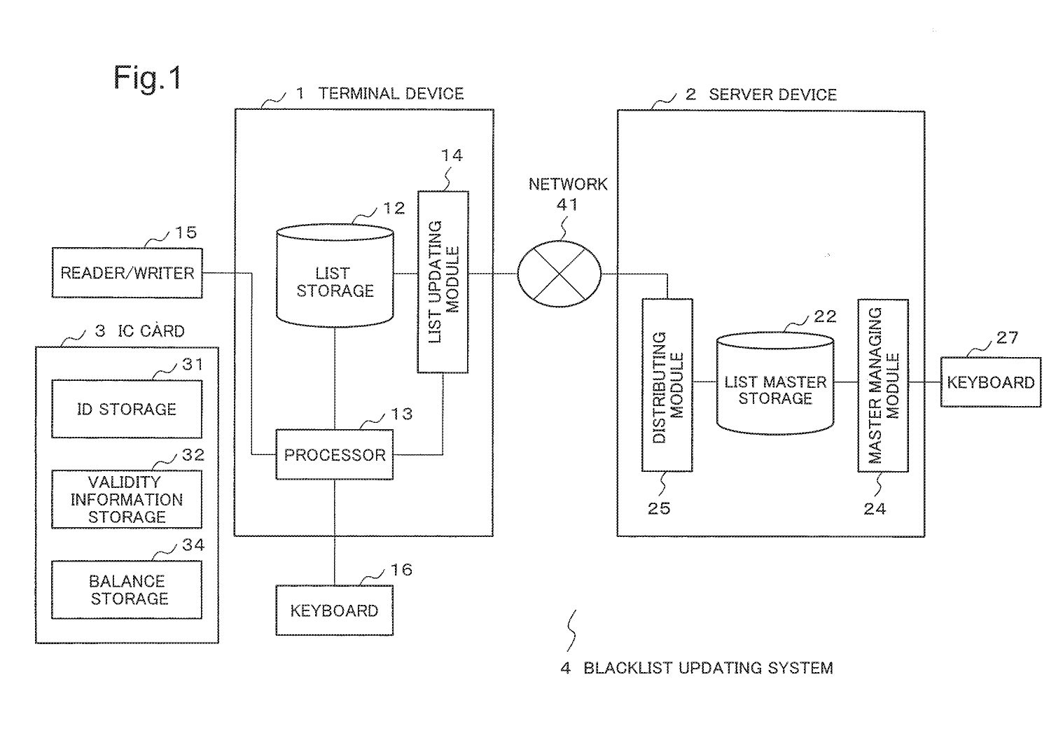

FIG. 1 is a configuration diagram of a blacklist updating system 4 according to the present exemplary embodiment. The blacklist updating system 4 includes a terminal device 1 and a server device 2 connected via a network 41. There are commonly a plurality of terminal devices 1. The terminal device 1 is set at, for example, a payment counter of a dealer. The server device 2 is set in, for example, a bank or a credit card company.

The terminal device 1 includes a list storage 12, a processor 13, and a list updating module 14. The processor 13 is connected with a reader/writer 15 and a keyboard 16.

The reader/writer 15 is an RFID (Radio Frequency IDentification) reader/writer that reads and writes data stored on an IC (Integrated Circuit) card 3. The IC card 3 is, for example, a portable recording medium that stores electronic money. Alternatively, the IC card 3 may be a credit card. A holder of the IC card 3 pays a purchase price for a product or a service with the IC card 3 at a dealer.

The IC card 3 includes an ID storage 31 that stores a card ID or a user ID (IDentification, hereinafter, referred to simply as an ID), a validity information storage 32 that stores validity information indicating that the IC card 3 is valid or invalid, and a balance storage 34 that stores a balance of electronic money stored thereon or a credit balance of a credit card.

A holder of an IC card 3 can pay with the IC card 3 only when validity information stored on the validity information storage 32 indicates valid. The holder can perform payment, for example, within a range of an amount of money stored on the balance storage 34.

When, for example, a legitimate holder loses an IC card 3 and then applies for a use stop of the IC card 3 to a bank or a credit card company, the IC card 3 becomes invalid. When, for example, the legitimate holder finds the IC card 3 at home and then applies for a release of the use stop to the bank or the credit card company, the IC card 3 is returned to be valid. Further, in the case of being a credit card, the IC card 3 becomes invalid by an operation of the server device 2 of a credit card company when, for example, it is impossible to withdraw a billed amount from a bank account, and thereafter the IC card 3 is returned to be valid by an operation of the server device 2 of the credit card company when money is deposited in the bank account and it becomes possible to perform a withdrawal.

Valid information indicating invalid is stored on the validity information storage 32 of an IC card 3 being invalid when the IC card 3 is tapped to the reader/writer 15 of the terminal device 1. Therefore, a time difference is generated between an invalid state of the IC card 3 and storage of valid information indicating invalid. In the same manner, a time difference is generated between a return to a valid state of the IC card 3 and storage of valid information indicating valid.

The list storage 12 of the terminal device 1 stores a blacklist 61 indicating an ID of an invalidated IC card 3. When an ID read out from an IC card 3 has been registered on the blacklist 61 stored on the list storage 12, the processor 13 records invalid on the validity information storage 32 of the IC card 3. When validity information read out from the IC card 3 indicates valid, the processor 13 executes a predetermined process, for example, a payment process.

The list updating module 14 receives, for example, a new blacklist 61 from the server device 2 and stores the received blacklist 61 on the list storage 12. The server device 2 creates and updates an original of the blacklist 61 and distributes the updated original to the terminal device 1 via the network 41. The list updating module 14 of the terminal device 1 receives the updated original, stores the original on the list storage 12, and thereby stores a duplicate of the blacklist 61. The distribution of the blacklist 61 may be performed through mailing of an interchangeable medium or the like instead of communication.

The processor 13 and the list updating module 14 each include a logic circuit or the like. It is possible that they are implemented using software which is stored on a memory (not illustrated) of the terminal device 1 that is a computer and executed by a processor (not illustrated) of the terminal device 1. The list storage 12 is a storage device such as an IC memory, a disk device, or the like.

The server device 2 includes a list master storage 22, a master managing module 24, and a distributing module 25. The master managing module 24 is connected with a keyboard 27.

When acquiring an ID of an IC card 3 to be invalidated from the keyboard 27, the master managing module 24 adds the ID and the like to the original of the blacklist 61. When acquiring an ID of an IC card 3 to be returned to be valid from being invalid from the keyboard 27, the master managing module 24 deletes the ID and the like from the original of the blacklist 61. The list master storage 22 stores the original of the blacklist 61.

The distributing module 25 distributes a duplicate of the blacklist 61 stored on the list master storage 22, for example, to all the terminal devices 1 regularly. When receiving a request for update data from a certain terminal device 1, the distributing module 25 transmits a duplicate of the blacklist 61 stored on the list master storage 22 to the terminal device 1 having transmitted the request.

The master managing module 24 and the distributing module 25 each include a logic circuit or the like. It is possible that they are implemented using software which is stored on a memory (not illustrated) of the server device 2 that is a computer and executed by a processor (not illustrated) of the server device 2. The list master storage 22 is a storage device such as an IC memory, a disk device, or the like.

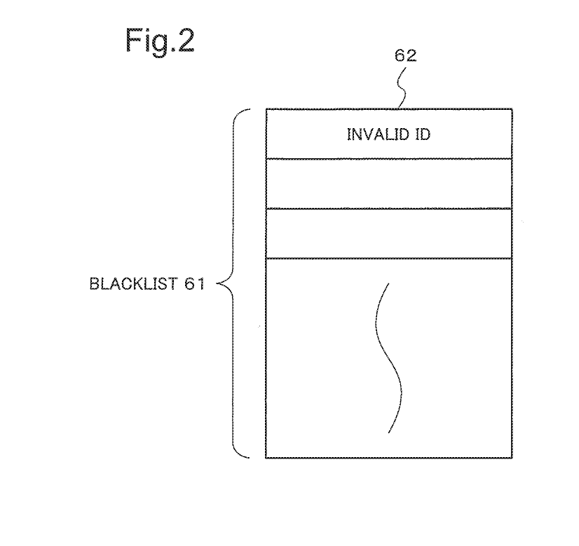

FIG. 2 illustrates a configuration of the blacklist 61 stored on the list storage 12 of the terminal device 1 and the list master storage 22 of the server device 2. The blacklist 61 is a list of an invalid ID 62 that is an ID of an invalidated IC card 3.

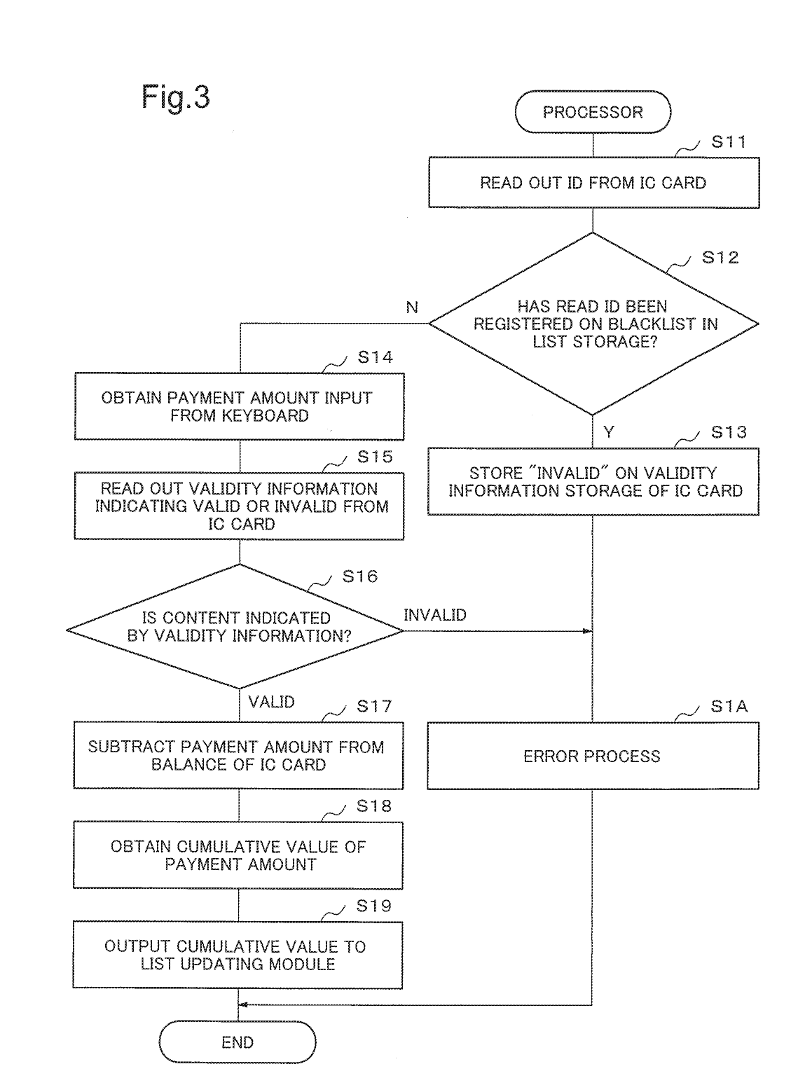

FIG. 3 is an operation flowchart of the processor 13 of the terminal device 1. The processor 13 is started when, for example, an IC card 3 is tapped to the reader/writer 15.

The processor 13 reads out an ID from an IC card 3 (S11). The ID is read out from the ID storage 31.

The processor 13 checks whether the read ID has been registered on the blacklist 61 stored on the list storage 12 (S12). At that time, the processor 13 checks whether an invalid ID 62 matched with the read ID has been registered on the blacklist 61. When the registration has been performed (Y in S12), the processor 13 stores validity information of “invalid” on the validity information storage 32 (S13), executes an error process (S1A), and terminates the processing. The error process is, for example, a process for outputting a report that the IC card 3 is invalid to a display device, not illustrated, of the terminal device 1.

When the read ID has not been registered on the blacklist 61 stored on the list storage 12 (N in S12), the processor 13 initially obtains a payment amount input from the keyboard 16 (S14) and then reads out validity information of valid or invalid from the IC card 3 (S15). The validity information is read out from the validity information storage 32.

When the validity information indicates “valid” (valid in S16), the processor 13 executes a predetermined process for achieving an original purpose using the IC card 3, for example, a payment process for subtracting a payment amount from a balance of electronic money recorded on the balance storage 34 of the IC card 3 (S17). The predetermined process does not generally include a request for processing to the server device 2 that stores the original of the blacklist 61 but may include the request.

Thereafter, the processor 13 determines a cumulative value related to payment processes (S18) and outputs the cumulative value to the list updating module 14 (S19). The cumulative value refers to, for example, a cumulative value of amounts of money for which the terminal device 1 has executed payment processes, a cumulative count in which the terminal device 1 has executed payment processes, or a cumulative value of the number of IDs for which the terminal device 1 has executed payment processes (when the same ID has been processed at multiple times, the processor 13 does not increase the cumulative value). As the cumulative value, another value may be used, as long as it reflects an amount of payment processes.

When the validity information indicates “invalid” (invalid in S16), the processor 13 executes an error process (S1A) and terminates the processing.

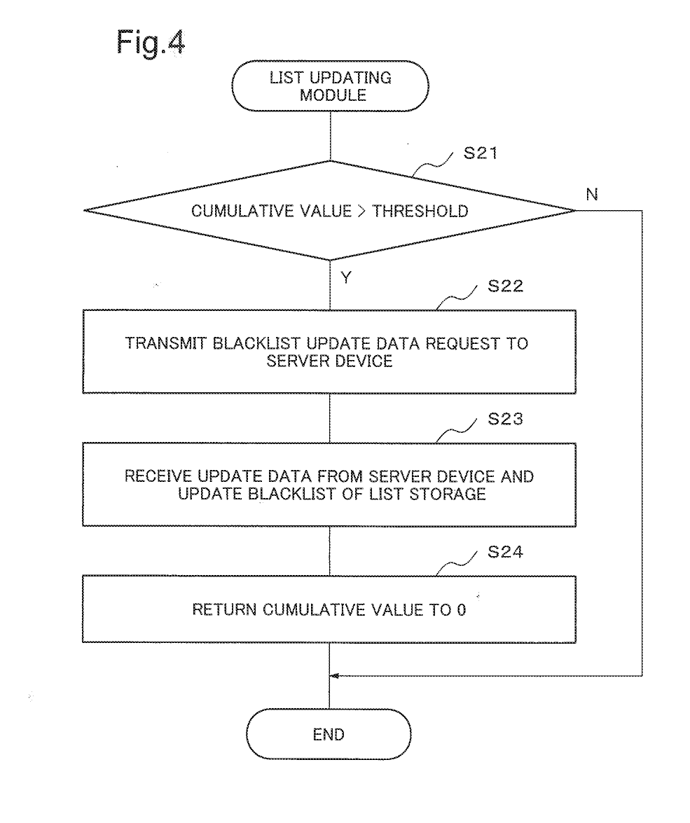

FIG. 4 is an operation flowchart of the list updating module 14. When a cumulative value acquired from the processor 13 is larger than a predetermined threshold (Y in S21), the list updating module 14 issues a request for update data of the blacklist 61 to the server device 2 (S22). Specifically, the list updating module 14 transmits, to the distributing module 25 of the server device 2, an update data transmission request.

When receiving the update data from the distributing module 25 of the server device 2, the list updating module 14 updates the blacklist 61 stored on the list storage 12 with the update data (S23) and returns the cumulative value to zero (S24).

The distributing module 25 of the server device 2 may transmit all of the blacklist 61 or transmits only difference data after transmission of the last time as the update data. When receiving all of the blacklist 61, the list updating module 14 replaces the blacklist 61 of the list storage 12 with the received data. When receiving the difference data, the list updating module 14 updates the blacklist 61 of the list storage 12 with the received data.

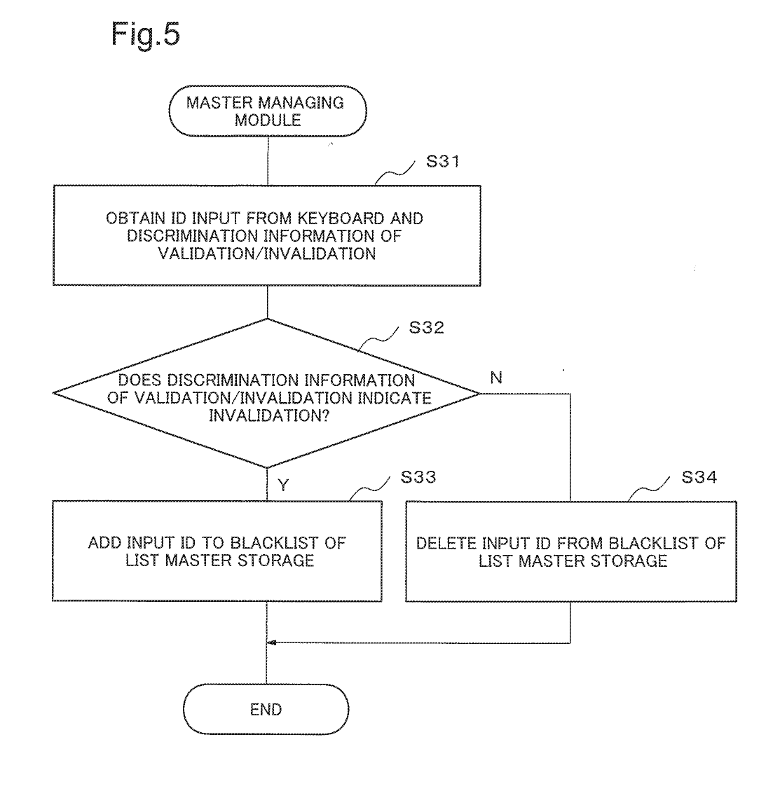

FIG. 5 is an operation flowchart of the master managing module 24 of the server device 2. The master managing module 24 is started when an instruction for invalidation or validation of an IC card 3 is input from the keyboard 27 or the like.

Initially, the master managing module 24 obtains discrimination information of whether an IC card 3 is validated or invalidated and an ID from the keyboard 27 (S31). When the discrimination information indicates invalidation (Y in S32), the master managing module 24 adds the input ID to the blacklist 61 stored on the list master storage 22 (S33). When the discrimination information indicates validation (N in S32), the master managing module 24 deletes the input ID from the blacklist 61 stored on the list master storage 22 (S34).

The distributing module 25 distributes the blacklist 61 in the list master storage 22 maintained/managed by the master managing module 24 in this manner to the terminal device 1.

The distribution may be performed regularly or when addition or deletion has been performed at a certain number of times. In this case, the distributing module 25 may uniformly perform the distribution to all the terminal devices 1 or may perform the distribution at different timings for respective groups by grouping the terminal devices 1.

Further, when receiving an update data transmission request from the terminal device 1, the distributing module 25 transmits the blacklist 61 in the list master storage 22 to the terminal device 1 of a transmission source thereof.

The blacklist updating system 4 according to the present exemplary embodiment can efficiently prevent illegal use of an IC card 3 including an invalidated ID. In other words, the present system can control an update frequency of the blacklist 61 in accordance with a height of a risk of illegal use of the IC card 3 with respect to each terminal device 1. The reason is that when a process cumulative amount of a payment process and the like after the last receiving of update data is larger than a threshold, the terminal device 1 requests update data of the server device 2, acquires the update data, and updates the blacklist 61 stored on the list storage 12 therewith.

The terminal device 1 having a large payment process amount has a high risk of illegal use of an invalidated IC card 3, and therefore it is preferable to update the blacklist 61 frequently from the viewpoint of risk prevention. The reason is that a person who makes illegal use is expected to use an invalidated IC card 3 repeatedly at a specific store or the like.

The IC card 3 may be changed to an IC memory of another shape or another recording medium, for example, a USB (Universal Serial Bus) memory. In this case, the reader/writer 15 is changed to a USB interface. Further, the IC card 3 may be replaced with a recording medium provided for the exterior of a car or a wheelchair and used, for example, for drive-through payment, instead of a subject carried by a person. The IC card 3 may not include the validity information storage 32 or the balance storage 34. The terminal device 1 may store a payable balance.

Further, the card may be not an IC card 3 but a magnetic card. In this case, the reader/writer 15 is a magnetic reader/writer.

Further, the card may be a plastic card in which an ID is printed on a surface thereof. In this case, the ID may be input from the keyboard 16 or a bar code reader, not illustrated, by an employee of a store.

A predetermined process regarded as a cumulative target of an execution count or the like may be a process other than a process in which processing is requested of the server device 2 and a completion of the processing is awaited. The reason is that when the predetermined process is a process in which processing is requested of the server device 2, the server device 2 can determine valid/invalid of an ID. However, when the predetermined process is a case in which processing is requested of the server device 2 and whether a completion thereof is awaited depends on an external condition, a case in which the server device 2 does not determine valid/invalid of an individual ID, or the like, such a case may be used as the predetermined process regarded as a cumulative target.

When receiving an update data transmission request from a certain terminal device 1, the distributing module 25 may transmit update data to not only the request transmission source terminal but also a terminal device 1 geographically close to the terminal. The reason is that a person who makes illegal use may use an invalidated IC card 3 repeatedly at one store or the like and also use the invalidated IC card 3 at a neighboring store.

The predetermined process may be a recharge process instead of a payment process. In this case, the processor 13 is connected with a cash deposit device not illustrated. The processor 13 obtains, from the cash deposit device, a deposited amount of money of cash and adds the amount of money to the balance storage 34 of the IC card 3.

A cumulative value accumulated by the processor 13 may be substantially regularly reset to 0 at a predetermined period. In this case, the list updating module 14 updates the blacklist 61 when the cumulative value within the predetermined period is larger than a threshold.

When the terminal device 1 has not successfully received update data of the blacklist 61 due to a communication failure or the like, the terminal device 1 may stop a payment process thereafter. The reason is that a person who makes illegal use may destroy a communication facility or the like of the terminal device 1 and thereby hinder an update of the blacklist 61.

Specifically, when, for example, the terminal device 1 has not successfully received update data of the blacklist 61 due to a communication failure or the like in S22 or S23, the list updating module 14 notifies the processor 13 of the fact. The processor 13 stops a payment process after reception of the notification.

### Second Exemplary Embodiment

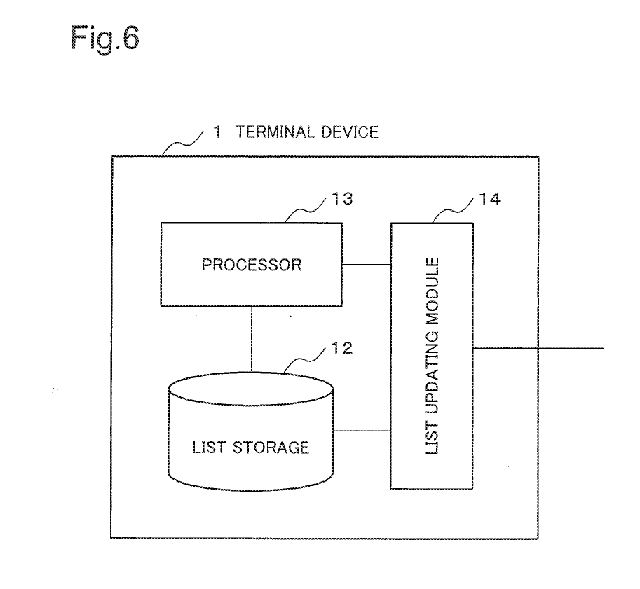

FIG. 6 is a configuration diagram of a terminal device 1 according to a second exemplary embodiment.

The terminal device 1 according to the present exemplary embodiment includes the list storage 12, the processor 13, and the list updating module 14.

The list storage 12 stores a blacklist 61 including an invalidated identifier. When an amount of money or an identifier is input, the processor 13 checks whether the input identifier is included in the blacklist 61 in the list storage 12. When the input identifier is not included in the blacklist 61, the processor 13 executes a predetermined process using the amount of money and accumulates a predetermined value to obtain a cumulative value. When the cumulative value is larger than a predetermined threshold, the list updating module 14 receives update data from the server device 2 and updates the blacklist 61 in the list storage 12.

The terminal device 1 according to the present exemplary embodiment can efficiently prevent illegal use of an IC card or the like including an invalidated ID. In other words, the terminal device 1 can control an update frequency of the blacklist 61 in accordance with a height of a risk of illegal use of an IC card. The reason is that when a process cumulative amount of a payment process and the like after the last receiving of update data is larger than a threshold, the terminal device 1 requests update data of a server device, acquires the update data, and updates the blacklist 61 stored on the list storage 12 therewith.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese Patent Application No. 2013-193674, filed on Sep. 19, 2013, the disclosure of which is incorporated herein in its entirety by reference.

### REFERENCE SIGNS LIST

1 Terminal device

2 Server device

3 IC card

4 Blacklist updating system

12 List storage

13 Processor

14 List updating module

15 Reader/writer

16, 27 Keyboard

22 List master storage

24 Master managing module

25 Distributing module

31 ID storage

32 Validity information storage

34 Balance storage

41 Network

61 Blacklist

62 Invalid ID

What is claimed is:

1. A terminal device comprising:
a list storage which stores a blacklist including invalidated identifiers;
a processor which checks, when an amount of money and the identifier are inputted, whether the input identifier is included in the blacklist in the list storage means and, when not included, executes a predetermined process using the amount of money and accumulates a predetermined value to obtain a cumulative value; and
a list updating module which receives update data from a server device to update the blacklist in the list storage means when the cumulative value is larger than a predetermined threshold.

2. The terminal device according to claim 1, wherein the cumulative value is any one of a cumulative value of the amount of money, an execution count of the predetermined process, and a number of the identifiers as targets of the predetermined process.

3. The terminal device according to claim 1, wherein
the predetermined process does not include processing for transmitting a request of server processing to the server device and awaiting a completion of the server processing, and
even when the cumulative value is larger than the threshold, the processor does not execute the predetermined process when the list updating module has not successfully received the update data.

4. The terminal device according to claim 1, wherein
the processor reads the identifier from a recording medium that stores the identifier, a payable balance, and validity information indicating valid or invalid; and executes, as the predetermined process, a payment process that subtracts the amount of money from the payable balance when the read identifier is not included in the blacklist in the list storage and the validity information indicates valid, and stores the validity information indicating invalid on the recording medium and does not execute the payment process when the read identifier is included in the blacklist in the list storage.

5. A blacklist updating system comprising:
the terminal device according to claim 1; and
the server device that stores an original of the blacklist, adds, when inputting a newly invalidated identifier, the input invalidated identifier to the original of the blacklist, deletes, when inputting an identifier returned to be valid from being invalid, the input valid identifier from the original of the blacklist, and transmits a duplicate of the original of the blacklist to the terminal device when receiving a request from the terminal device.

6. A method comprising:
storing a blacklist including invalidated identifiers;
checking, when an amount of money and the identifier are inputted, whether the input identifier is included in the stored blacklist and, when not included, executing a predetermined process using the amount of money and accumulating a predetermined value to obtain a cumulative value; and
receiving update data from a server device to update the stored blacklist when the cumulative value is larger than a predetermined threshold.

7. The method according to claim 6, wherein the cumulative value is any one of a cumulative value of the amount of money, an execution count of the predetermined process, and a number of the identifiers as targets of the predetermined process.

8. The method according to claim 6, wherein
the predetermined process does not include processing for transmitting a request of server processing to the server device and awaiting a completion of the server processing, and
even when the cumulative value is larger than the threshold, not executing the predetermined process when the update data has not been successfully received.

9. The terminal device according to claim 6, wherein
reading the identifier from a recording medium that stores the identifier, a payable balance, and validity information indicating valid or invalid; and executing, as the predetermined process, a payment process that subtracts the amount of money from the payable balance when the read identifier is not included in the stored blacklist and the validity information indicates valid, and storing the validity information indicating invalid on the recording medium and not executing the payment process when the read identifier is included in the stored blacklist.

10. A non-transitory computer readable storage medium recording thereon a program, causing a computer to perform the method according to claim 6.

11. A terminal device comprising:
a list storage means for storing a blacklist including invalidated identifiers;
a processing means for checking, when an amount of money and the identifier are inputted, whether the input identifier is included in the blacklist in the list storage means and, when not included, executing a predetermined process using the amount of money and accumulating a predetermined value to obtain a cumulative value; and
a list updating means for receiving update data from a server device to update the blacklist in the list storage means when the cumulative value is larger than a predetermined threshold.
